(19) United States
(12) Patent Application Publication
(10) Pub. No.: US 2002/0191649 A1
(43) Pub. Date: Dec. 19, 2002

(54) Port mirroring in channel directors and switches

(76) Inventor: Sherrie L. Woodring, Fairfax, VA (US)

Correspondence Address: BAKER & HOSTETLER LLP, Washington Square, Suite 1100, 1050 Connecticut Avenue, N.W., WASHINGTON, DC, 20036, US

(21) Appl. No.: 10/026,706

(22) Filed: Dec. 27, 2001

Related U.S. Application Data
(60) Provisional application No. 60/297,439, filed on Jun. 13, 2001.

(51) Int. Cl. H04L 12/28

(52) U.S. Cl. 370/906

(57) ABSTRACT

A storage area network that includes a monitoring component, wherein the monitoring component is capable of characterizing data flowing into or out of at least one port associated with a fiber channel director or switch so as to enable an operator to ascertain some usable information regarding the characterized data and/or its impact on the network. In many embodiments, the monitoring component provides a visual or audible signal to the operator regarding a particular data component. The present invention is further directed to methods for monitoring a storage area network, in particular, at least one port associated therewith.

### PRIORITY

This application claims priority to the [provisional] U.S. patent application entitled, Port Mirroring in Channel Directors and Switches, filed Jun. 13, 2001, having a Ser. No. 60/297,439, the disclosure of which is hereby incorporated by reference.

### FIELD OF THE INVENTION

The present invention relates generally monitoring information being sent and/or received in a device and more particularly, to monitoring bi-directional datastreams in a Fibre Channel environment by mirroring the transmit and receive side of a port to a probe.

### BACKGROUND OF THE INVENTION

As organizations seek out cost-effective ways to manage the virtual explosion of information created by eBusiness and other initiatives, they are turning to Storage Area Networks (SANs). SANs are a networked storage infrastructure designed to provide a flexible environment that decouples servers from their storage counterparts. SANs accomplish this by providing any-server-to-any-storage connectivity through the use of Fibre Channel switch and director fabric technology (commonly referred to as the SAN fabric).

Moreover, users of SANs would be eager to have a method for visually inspecting the type and nature of traffic going through the SAN fabric at any given moment or at any given port location in order to provide the best maintenance and service of the network as possible at any given moment, and throughout the life of the network. In addition, it would be useful for administrators of networks to be able to have a methodology for predicting maximum usage requirements, monitoring service levels and future needs of each device associated therewith.

To deliver a highly available and performing storage infrastructure for business critical applications, administrators face many challenges when managing a SAN:

managing data with fewer IT resources,

managing infrastructure and application changes on a daily basis, delivering system and application performance and

managing flexible deployment of multiple applications across a common infrastructure.

Monitoring the quality of service for a SAN is critical to meeting IT availability and performance goals. It would be desirable to have real-time and trend performance data for critical service-level parameters such as availability, throughput, and utilization. Real-time performance monitoring, with flexible user-defined thresholds, allows administrators to quickly pinpoint issues that could affect overall SAN performance. Historical trending of performance data extends the administrator's capability to audit and validate service-level agreements. While most SAN fabrics provide port level statistics (e.g., MB/sec), they do not provide statistics at the device level (e.g., per server, per LUN) for a given fiber channel port connected to a fabric. In order to get device level statistics, one method is to access the data stream through routing a mirrored copy of all data received and transmitted on any fabric port to a probe. The probe then monitors the data stream to measure service level metrics at the port and device level.

### SUMMARY OF THE INVENTION

In accordance with these and other objects, the present invention is directed to a storage area network that includes a monitoring component, wherein the monitoring component is capable of characterizing data flowing into or out of at least one port associated with the network so as to enable an operator to ascertain some usable information regarding the characterized data and/or its impact on the network. In many embodiments, the monitoring component provides a visual or audible signal to the operator regarding a particular data component. The present invention is further directed to methods for monitoring a storage area network, in particular, at least one port associated therewith.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a diagram of a typical storage area network and associated devices.

FIG. 2 is a diagram showing port mirroring in the fiber channel director according to the present invention for N_Ports

FIG. 3 is a diagram showing port mirroring in the fiber channel director according to the present invention for E₁₃ Ports (ISLs)

FIG. 4 is a diagram of a probe system according to the present invention.

FIG. 5 is an architecture employed in one embodiment of a probe system according to the present invention.

FIG. 6 is an architecture employed in another embodiment of a probe system according to the present invention.

FIG. 7 is an implementation of a probe system according to the present invention.

### DETAILED DESCRIPTION OF PREFERRED EMBODIMENTS OF THE INVENTION

According to a preferred embodiment, the present apparatus and methods include mirroring of both transmit and receive side of a port in a fibre channel director or switch. Mirroring, in a preferred embodiment, involves copying all ingress and egress fiber channel frames and primitives for a particular port to a monitoring device (e.g., probe) directly connected to the fabric. The signal being mirrored could be fiber channel (e.g., 1 GB or 2 GB), GigE (e.g., iSCSI or FCIP) or any other type of signal used by a SAN fabric. By replicating the signal using port mirroring, it is possible to keep up-to-the-minute statistics on the nature of data then associated with that particular port by viewing the information provided by the probe. The information could be displayed or stored according to any known mechanism including by graphical representations, time based reports, polling of ports, event-based triggers, and the like. The present invention provides many benefits over such prior maintenance systems such as optical splitters, fiber channel patch panels or cross-connects that require cumbersome installation and wiring and associated floor space and equipment costs.

By employing the present apparatus and/or methods, it is possible to always have current information in terms of the nature of the data then associated with a port as well as its relative contribution to the total traffic in the SAN fabric. It is further possible to have a record of the particular traffic at a particular timeframe so as to permit intelligent decision-making by operators as to what devices are contributing to problems experienced by the system.

Fibre channel systems are most often the directors employed in the present storage area marketplace, and as such, the present invention was contemplated with this in mind. However, the invention could, of course, be adapted to other directors and architectures depending on the desired end use without undue experimentation. Fibre Channel topology can be selected depending on system performance requirements or packaging options. Possible fibre channel topologies include point-to-point, crosspoint switched or arbitrated loop. In any of these fibre channel topologies, SCSI storage devices, such as hard disk storage devices and tape devices, can be used to store data that can be retrieved by a software application. Conventionally, fibre channel storage devices have been directly attached to a fibre channel I/O bus on a server.

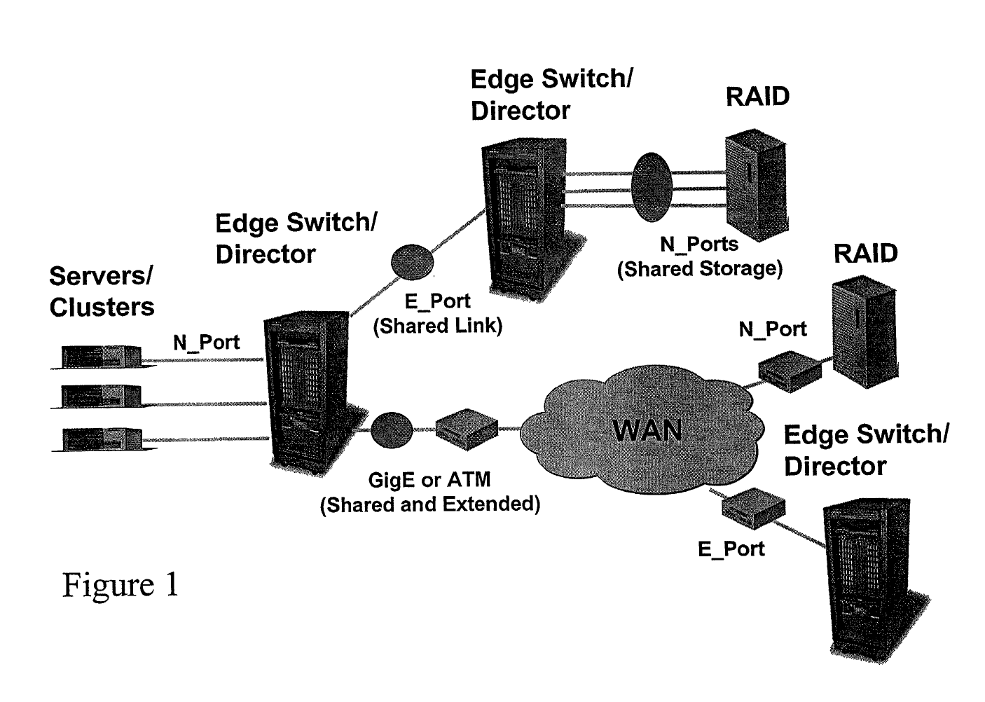

As shown, for example, in FIG. 1, there is shown an exemplary configuration for a storage area network including a WAN. According to the present invention, it is possible to determine which device(s) are contributing to traffic by mirroring a port's receive and transmit ports to a probe connected to another director port. It is further possible to determine what type of device traffic in terms of read/write, transaction vs. large file I/O. Other aspects of the present invention are capable of ascertaining whether any retransmissions are occurring in the network and which device(s) are responsible for such retransmission and to what extent a particular device is impacting the network due to such retransmission on a real-time basis if desired for a particular reason. These and other aspects of the present invention are provided by virtue of the inclusion of a probe system that gathers statistics directly from Fibre Channel links. Statistics are gathered per Fibre Channel link and per device (e.g., 24 bit Fibre Channel ID).

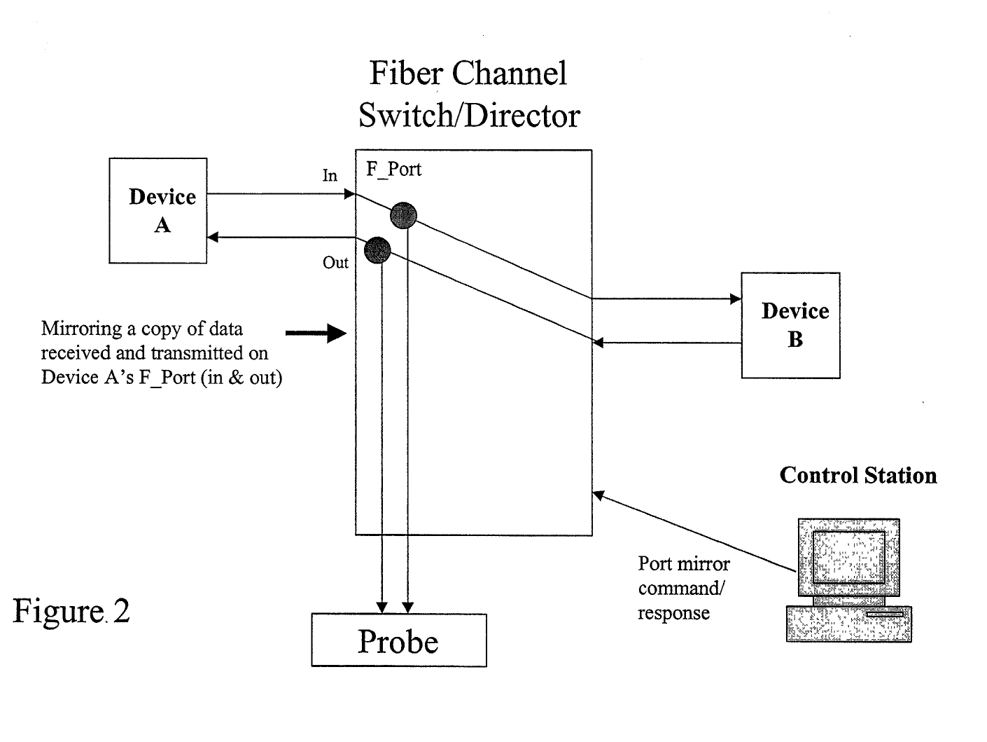

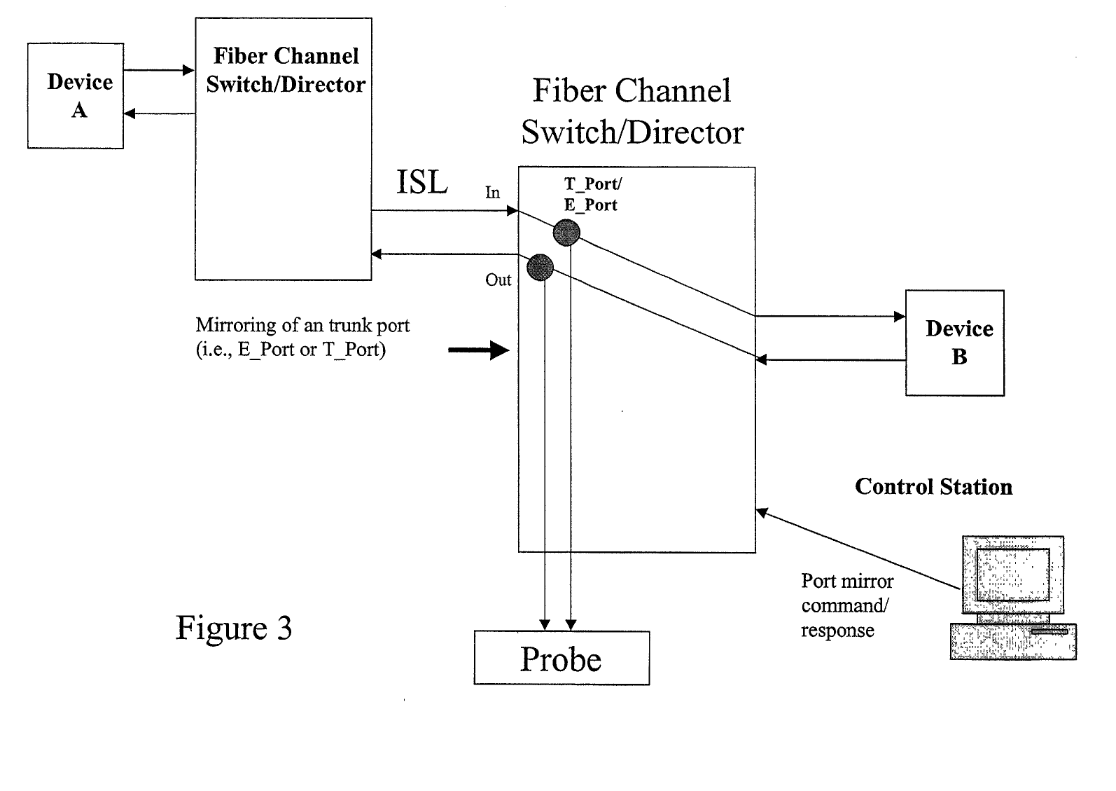

As shown in FIGS. 2 and 3, below is described an exemplary methodology for implementing the port mirroring according to the present invention:

1. Mirrored port preferably is capable of monitoring both the transmit and receive side of an attached N_Port, T_Port, E_Port, or any other port connected to the fabric. Two ports on a fibre channel director constitute one mirror port. Traffic received on the F_Port is mirrored to port 1 in the pair (In), traffic transmitted from the F_Port is mirrored to port 2 in the pair (Out). This is done to ensure directional consistency.

2. Configuration of the mirror port shall be done from a Control Station using in-band or out-of-band control interface.

3. A mirrored port is preferably able to monitor any port on a 32, 64, or 128 port director, or other sizes as needed or desired.

4. A mirrored port is preferably capable of monitoring any port on a director switch, even those switches that include 256 ports.

5. A mirrored port is generally capable of monitoring ports on the director to which it is connected (i.e., remote mirroring is optional and not necessary in some embodiments).

6. Multiple mirror ports are preferably capable of being supported on one fiber channel director. The only limitation on mirroring may be a single mirror port per interface I/O card.

7. To establish the port mirror, a fibre channel director SNMP MIB, or other means, is generally capable of supporting the following Sets/Gets:

a. Set command that connects or disconnects a port mirror using port aliases or WWNs.

b. Get command to retrieve status on which port(s) are currently being mirrored.

8. SNMP port mirroring Set/Get commands are generally capable of being supported as an in-band command (i.e., a probe system according to the present invention talks to one director to mirror any port on any director). In other embodiments, the probe system is capable of communicating with multiple directors via their associated IP address.

9. The mirrored port can mirror both fiber channel primitives (e.g., R_RDY) and frames. Fiber channel frames include error-free frames, busy frames, CRC error frames, rejected frames, and discarded frames, and so on.

10. The mirrored port may optionally have a FLOGI sequence, however in some embodiments, the probe system of the present invention does not generate data, but merely receives data from the mirrored port(s) being monitored. If data generation would be useful, however, the system could be easily adapted without undue experimentation by those of skill in the art.

11. Port mirroring according to the present invention is generally capable of being supported independent of the Class of Traffic (e.g., Class 2 or Class 3).

As access to storage grows exponentially, a probe system according to the present invention enables the administrator to manage availability and performance by:

Driving towards 100% uptime through proactive monitoring-knowing something will fail before it does,

Isolating problems instantaneously through real-time problem detection and reporting,

Monitoring I/O performance based on changing traffic types,

Planning infrastructure changes and growth through historical performance visibility, and

Knowing the impact of application and infrastructure changes proactively.

A probe system according to the present invention collects service-level performance data by directly monitoring the Fiber Channel, GigE or other director port I/O. For example, Fiber Channel ports that could significantly impact availability and performance of the SAN include that would be assessable using port mirroring:

E_Ports used for Inter-switch links (ISL) between edge switches and core directors or between core directors,

N_Ports on a RAID subsystem that are shared between one or more servers and applications,

E_Ports extended over the WAN using GigE or ATM transport for remote data access, disk mirroring, and data replication.

A probe system according to the present invention enables intelligent monitoring through user-definable threshold levels that ensure that those who need to know about critical events are notified in real time and when attention is required. A probe system according to the present invention provides service-level parameters at both the FC port and server (i.e., device) level. Performance visibility at the server level across a shared SAN port is an important aspect to the present invention as well as detailed port level monitoring. By having such information, an end user is able to properly plan, implement and managing SAN connectivity and performance. A probe system according to the present invention answers critical service-level question such as:

Who's contributing to the traffic (in MB/sec, SCSI IO/sec)?

What type of traffic (read/write percentages, transaction vs large file operations)?

When does the service degrade? Who contributes to this degradation?

Who's experiencing throughput problems (i.e., retransmissions)?

Who's experiencing availability (i.e., connectivity) problems (e.g., link resets)?

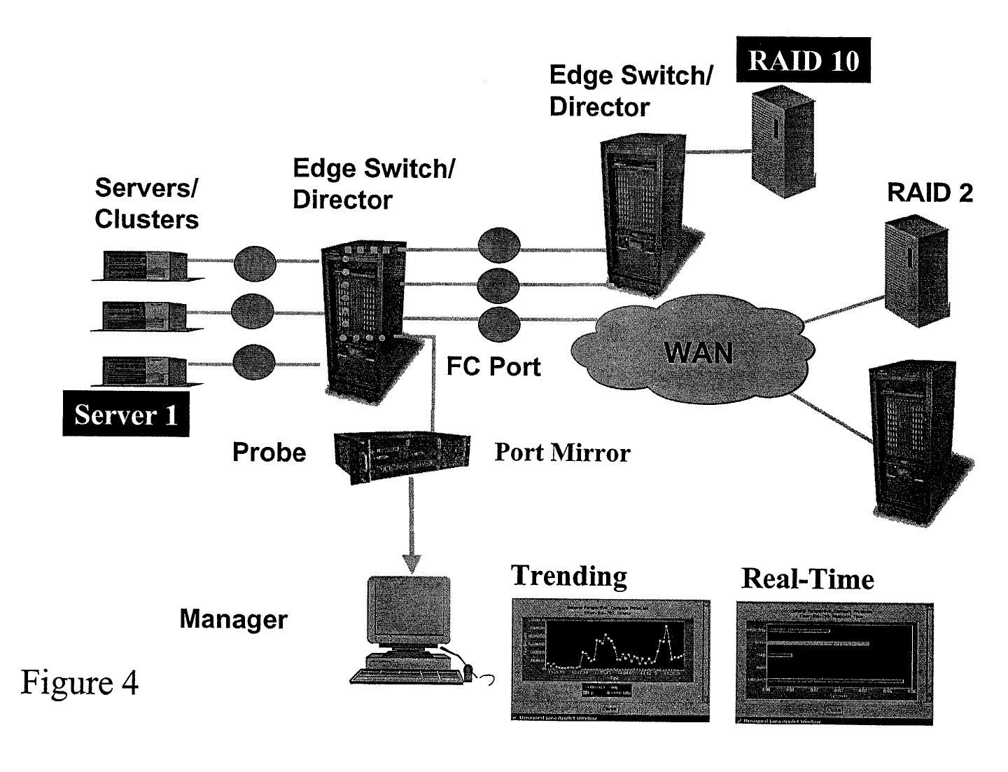

As shown in FIG. 4, it is possible to employ port mirroring in the Fiber Channel director or switch to access the Fibre Channel port through software control. The probe interface is connected to two FC ports on an director or switch I/O card. One port can be mirrored per I/O card, but more could be supported. The probe system according to the present invention is generally capable of commanding the channel director to mirror any E_Port, N_Port, or GigE port for bidirectional monitoring.

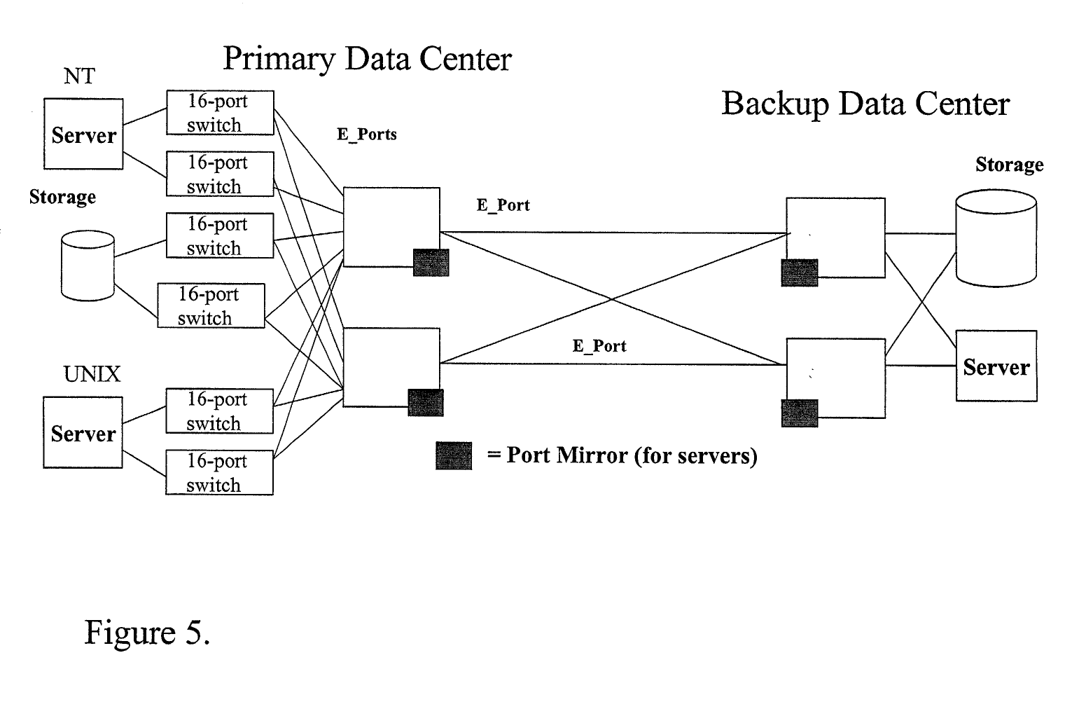

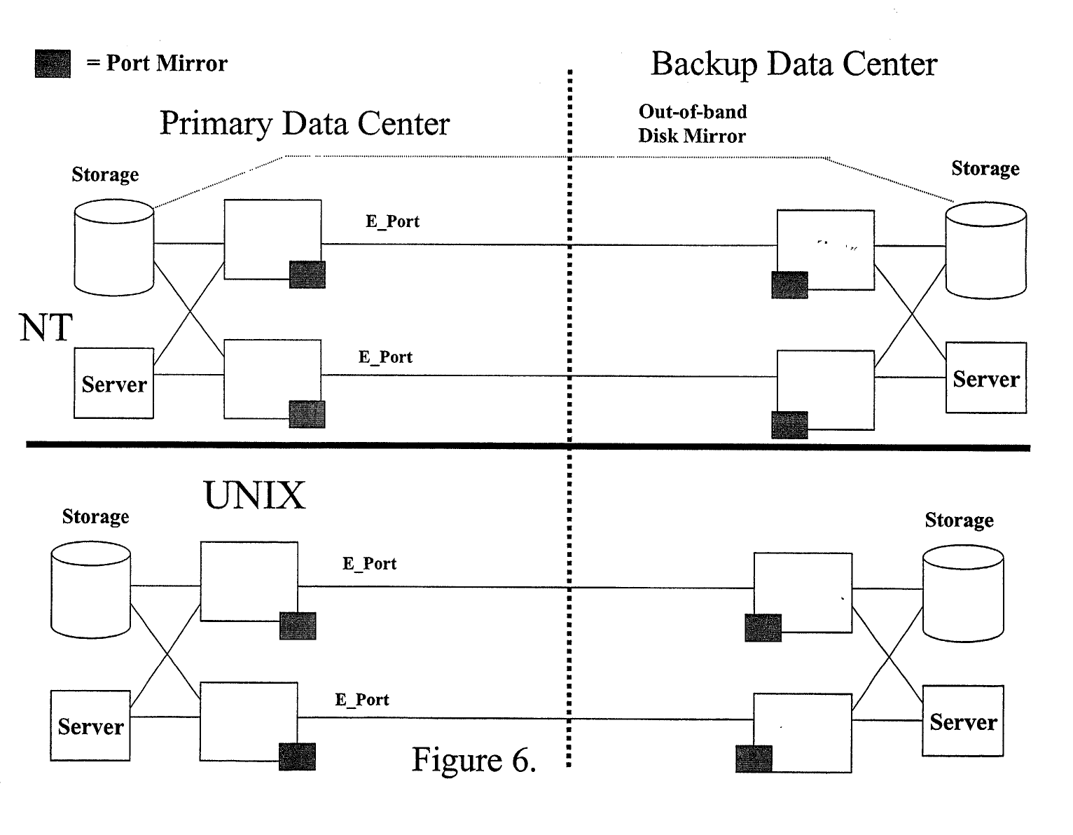

According to the proposed implementation of the present invention described in FIGS. 5 and 6, the SAN has no single point of failure within a Data Center. However, should the Primary Data Center experience multiple failures (e.g., redundant primary storage fails) or the entire Data Center goes off-line (e.g., disaster), then the Backup Data Center can assume partial or full operations through mirrored disks and/or redundant servers. Port mirroring enables the SAN manager to efficiently monitor any fiber channel port traversing the director for service level monitoring by a probe.

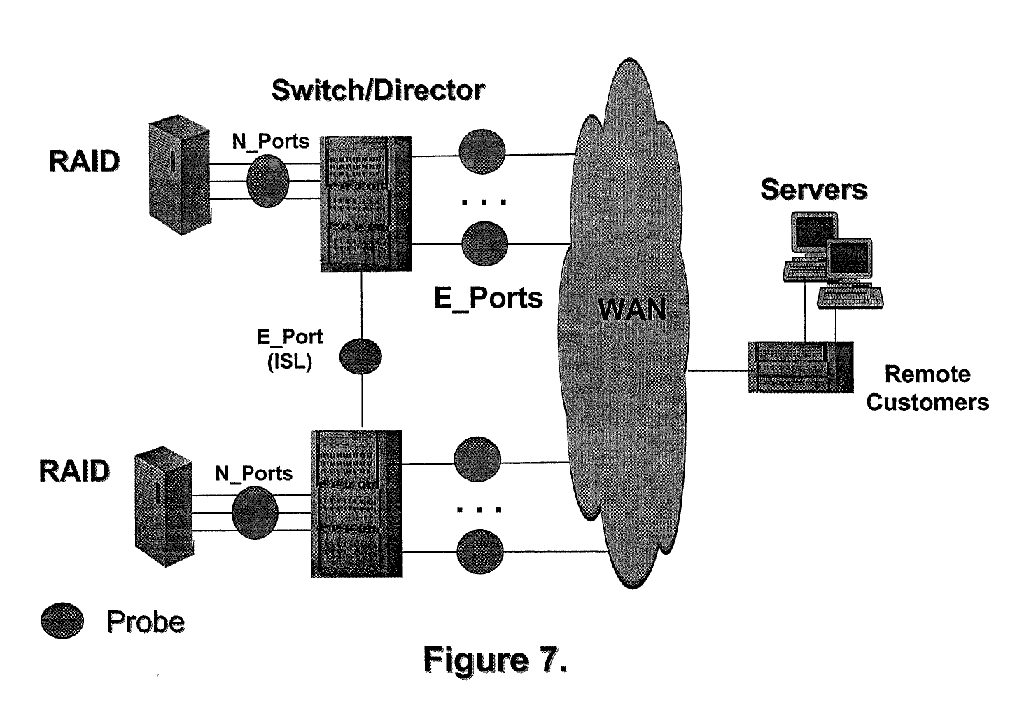

As shown, for example, in FIG. 7, service quality of the SAN in terms of utilization and availability at the port and device (e.g., Server) level for shared ISL ports is provided. Such an arrangement enables the SAN manager to plan and implement network moves/adds/changes and manage network service levels. Moreover, multiple ports are provisioned for a given RAID subsystem. A single N_Port to a RAID may transport data to/from multiple volumes accessed by multiple servers. To properly plan and implement network moves/adds/changes, the SAN manager needs to determine if a RAID port is oversubscribed or under-subscribed. If over-subscribed, he/she needs to know who is contributing to the load (e.g., which servers). Further, as shown in FIG. 7, server, RAID, and WAN ports are capable of being monitored via port mirroring.

As used herein, the following terms are intended to have the meanings set forth below which are believed to be consistent with known Fibre Channel technology:

8B/10B

The IBM patented encoding method used for encoding 8-bit data bytes to 10-bit Transmission Characters. Data bytes are converted to Transmission Characters to improve the physical signal such that the following benefits are achieved: bit synchronization is more easily achieved, design of receivers and transmitters is simplified, error detection is improved, and control characters (i.e., the Special Character) can be distinguished from data characters.

Arbitrated Loop

One of the three Fibre Channel topologies. Up to 126 NL_Ports and 1 FL_Port are configured in a unidirectional loop. Ports arbitrate for access to the Loop based on their arbitrate loop physical address (AL_PA). Ports with lower AL_PA's have higher priority than those with higher AL_PA's.

BB_Credit

Buffer-to-buffer credit value. Used for buffer-to-buffer flow control, this determines the number of frame buffers available in the port it is attached to, i.e., the maximum number of frames it may transmit without receiving an R_RDY.

Buffer-to-Buffer

(flow control)—This type of flow control deals only with the link between an N_Port and an F_Port or between two N_Ports. Both ports on the link exchange values of how many frames it is willing to receive at a time from the other port. This value becomes the other port's BB_Credit value and remains constant as long as the ports are logged in. For example, when ports A and B log into each other, A may report that it is willing to handle 4 frames from B; B might report that it will accept 8 frames from A. Thus, B's BB_Credit is set to 4, and A's is set to 8.

Each port also keeps track of BB_Credit_CNT, which is initialized to 0. For each frame transmitted, BB_Credit_CNT is incremented by 1. The value is decremented by 1 for each R_RDY Primitive Signal received from the other port. Transmission of an R_RDY indicates the port has processed a frame, freed a receive buffer, and is ready for one more. If BB_Credit_CNT reaches BB_Credit, the port cannot transmit another frame until it receives an R_RDY.

B_Port

A bridge port is a fabric inter-element port used to connect bridge devices with E-ports on a switch. The B_Port provides a subset of the E_port functionality.

Class n

Fibre Channel Classes of service. Fibre channel (FC-2) defines several Classes of service. The major difference between the Classes of service is the flow control method used. The same pair of communicating ports may use different Classes of service depending on the function/application being served. Note that Class 1 service is not well defined/supported for FC over WAN configurations. All FC over WAN discussions in this document are for the transport of Class 2 or Class 3 traffic (and Class F traffic—see below).

Class 1

A method of communicating between N_Ports in which a dedicated connection is established between them. The ports are guaranteed the full bandwidth of the connection and frames from other N_Ports may be blocked while the connection exists. In-order delivery of frames is guaranteed. Uses end-to-end flow control only.

Class 2

A method of communicating between N_Ports in which no connection is established. Frames are acknowledged by the receiver. Frames are routed through the Fabric, and each frame may take a different route. In-order delivery of frames is not guaranteed. Uses both buffer-to-buffer flow and end-to-end flow control. Class 2 & 3 are used most often in the industry.

Class 3

Class 3 is very similar to Class 2. The only exception is that it only uses buffer-to-buffer flow control. It is referred to a datagram service. Class 3 would be used when order and timeliness is not so important, and when the ULP itself handles lost frames efficiently. Class 3 is the choice for SCSI. Class 2 & 3 are used most often in the industry.

Class 4

Class 4 provides fractional bandwidth allocation of the resources of a path through a Fabric that connects two N_Ports. Class 4 can be used only with the pure Fabric topology. One N_Port will set up a Virtual Circuit (VC) by sending a request to the Fabric indicating the remote N_Port as well as quality of service parameters. The resulting Class 4 circuit will consist of two unidirectional VCs between the two N_Ports. The VCs need not be the same speed.

Like a Class 1 dedicated connection, Class 4 circuits will guarantee that frames arrive in the order they were transmitted and will provide acknowledgement of delivered frames (Class 4 end-to-end credit). The main difference is that an N_Port may have more than one Class 4 circuit, possibly with more than one other N_Port at the same time. In a Class 1 connection, all resources are dedicated to the two N_Ports. In Class 4, the resources are divided up into potentially many circuits. The Fabric regulates traffic and manages buffer-to-buffer flow control for each VC separately using the FC_RDY Primitive Signal. Intermixing of Class 2 and 3 frames is mandatory for devices supporting Class 4.

Class 5

The idea for Class 5 involved isochronous, just-in-time service. However, it is still undefined, and possibly scrapped altogether. It is not mentioned in any of the FC-PH documents

Class 6

Class 6 provides support for multicast service through a Fabric. Basically, a device wishing to transmit frames to more than one N_Port at a time sets up a Class 1 dedicated connection with the multicast server within the Fabric at the well-known address of hex‘FFFFF5’. The multicast server sets up individual dedicated connections between the original N_Port and all the destination N_Ports. The multicast server is responsible for replicating and forwarding the frame to all other N_Ports in the multicast group. N_Ports become members of a multicast group by registering with the Alias Server at the well-know address of hex‘FFFFF8’. The Class 6 is very similar to Class 1; Class 6 SOF delimiters are the same as used in Class 1. Also, end-to end flow control is used between the N_Ports and the multicast server.

Class F service

As defined in FC-FG, a service which multiplexes frames at frame boundaries that is used for control and coordination of the internal behavior of the Fabric.

Class N service

Refers to any class of service other than Class F.

Command Tag Queuing

A SCSI-2 feature that is used when the initiator wants to send multiple commands to the same SCSI address or LUN. Tagged queues allow the target to store up to 256 commands per initiator. Without tagged queues, targets could support only one command per LUN for each initiator on the bus. Per the SCSI-2 specification, tagged queue support by targets is optional.

Cut-through

(routing) In a LAN switching environment the action of transmitting a frame on one port before all of that frame has been received from another port. Done for reasons of speed rather than integrity. Cf store and forward.

E_Port

As defined in FC-SW-2, a Fabric expansion port which attaches to another E_Port to create an Inter-Switch Link.

Hard Zone

A Zone which is enforced by the Fabric, often as a hardware function. The Fabric will forward frames amongst Zone Members within a Hard Zone. The Fabric prohibits frames from being forwarded to members not within a Hard Zone. Note that well-known addresses are implicitly included in every Zone.

Hub (FC)

Hubs allow multiple FC ports (NL_Ports and at most one FL_Port) to interconnect in a FC-AL (arbitrated loop) topology. Hubs are often manageable, support the cascading of multiple Hubs to form larger FC-AL loops, and provide hot-plug for the FC-AL ports. Hubs may also provide full non-blocking performance on all ports by intelligently and dynamically allowing ports to arbitrate/communicate with each other independent of traffic on other loop ports (a hub/loop trick).

Initiator

An initiator is a SCSI device that requests an I/O process be performed by another SCSI device (a target).

iSCSI

A specification that covers the transport of SCSI

Fabric

As defined in FC-FG (see reference [7]), an entity which interconnects various Nx_Ports attached to it and is capable of routing frames using only the D_ID information in an FC-frame header. In the FC-SW-2 standard, the term Fabric refers to switches that conform to the SW operational layer.

Fabric Element

A Fabric Element is the smallest unit of a Fabric which meets the definition of a Fabric. A Fabric may consist of one or more Fabric Elements, interconnected E_Port to E_Port in a cascaded fashion, each with its own Fabric controller. To the attached N_Ports, a Fabric consisting of multiple Fabric Elements is indistinguishable from a Fabric consisting of a single Fabric Element.

F_Port

a port in the fabric where an N_port or NL_port may attach

FC

Fibre Channel (See FC-FS.)

FC-0

FC protocol layer defining physical characteristics (signaling, media, tx/rx specifications—See FC-PI)

FC-1

FC protocol layer defining 8B/10B character encoding and link maintenance (see FC-FS)

FC-2

FC protocol layer defining frame formats, sequence/exchange management, flow control, classes of service, login/logout, topologies, and segmentation/re-assembly.

FC-3

Services for multiple ports on one node (See FC-FS).

FC-4

Upper Layer Protocol (ULP) mapping. FC-4 defines how ULPs are mapped over FC-FS. Popular ULPs include SCSI, FICON, IP, and VI.

FC-AL-2

NCITS Project 1133-D, Fibre Channel Arbitrated Loop—2

FC-BB

NCITS Project 1238-D, Fibre Channel Backbone. The FC-BB specifications will provide the necessary mappings bridge between physically-separate instances of the same network definition, including MAC address mapping & translation, configuration discovery, management facilities and mappings of FC Service definitions. Currently the FC-BB specification covers only ATM and packet over SONET/SDH networks.

FC-BBW_ATM

An ATM WAN interface specification that interfaces with Fibre Channel Switches on one side and ATM on the other.

FC-BBW_SONET/SDH

A SONET/SDH WAN interface specification that interfaces with Fibre Channel Switches on one side and SONET/SDH on the other.

FC-FLA

NCITS TR-20, Fibre Channel Fabric Loop Attachment

FC-FS

NCITS Project 1311D, Fibre Channel Framing and Signaling Interface

FC-GS-3

NCITS Project 1356D, Fibre Channel Generic Services—3

FC-PH

NCITS Project 755-M, Fibre Channel Physcial and Signaling Interface. FC-PH-3 was the last version of the FC-PH series of specs. Physical and signaling interfaces are now covered in FC-PI and FC-FS.

FC-PI

NCITS Project 1306-D, Fibre Channel—Physical Interface.

FC-PLDA

NCITS TR-19, Fibre Channel Private Loop, SCSI Direct Attach

FC-TAPE

NCITS Project 1315D, Fibre Channel—Tape Technical Report

FC-VI

NCITS Project 1332D, Fibre Channel—Virtual Interface Architecture Mapping. This goal of FC-VI is to provide a mapping between FC and VIA (Virtual Interface Architecture) “to enable scalable clustering solutions.”

FCP

X3.269-1996, Fibre Channel Protocolfor SCSI

FCP-2

Fibre Channel Protocol for SCSI, second version.

FC-4

Fibre Channel Layer 4 mapping layer. (See FC-FS.)

FL_Port

a port in fabric where an N_Port or an NL_Port may attach

Fabric Login (FLOGI)

Fabric Login Extended Link Service. (See FC-FS.). An FC-2 defined process used by N/NL_Ports to

Frame

The basic unit of communication between two N_Ports. Frames are composed of a starting delimiter (SOF), a header, the payload, the Cyclic Redundancy Check (CRC), and an ending delimiter (EOF). The SOF and EOF contain the Special Character and are used to indicate where the frame begins and ends. The 24-byte header contains information about the frame, including the S_ID, D_ID, routing information, the type of data contained in the payload, and sequence/exchange management information. The payload contains the actual data to be transmitted, and may be 0-2112 bytes in length. The CRC is a 4-byte field used for detecting bit errors in the received frame.

G_Port

A generic Fabric_Port that can function either as an E_Port or an F_Port.

GL_Port

A generic Fabric_Port that can function either as an E_Port or an FL_Port.

GBIC

Gigabit Interface converter, these devices can be obtained in copper DB9, SSDC and Fibre Optic type connection. GBICS are hot swappable allowing reconfiguration to take place on a live system with no down time

HBA

(host bus adapter)—this is the card that fits into the server workstation to provide the interface between the processor and Fibre Channel connection (loop, fabric)

Hunt Group

A set of N_Ports with a common alias address identifier managed by a single node or common controlling entity. However, FC-FS does not presently specify how a Hunt Group can be realized.

Load Balancing

A network feature that attempts to “balance” WAN traffic over more than one link in such a way as to maximize performance. Note that in some implementations load balancing only attempts to equalize throughput across multiple WAN links.

LUN

(SCSI) Logical Unit Number. SCSI targets often support multiple LUNs (e.g. a device controller may manage multiple devices—each a separate LUN).

LUN Masking

Method for limiting/granting access to specific LUNs from specific ports (for example, LUN Masking may be based on physical ports or World Wide Names). Similar in concept to zoning, but at a SCSI logical unit level.

LUN Zoning

Same as LUN Masking.

N_Port

a port attached to a node for use with point to point or fabric topology. Generally a port attached to a host or device. N_Ports communicate with other N_Ports and with F_Ports.

NL_Port

a port attached to a node for use in all three FC topologies (loop, fabric, point-to-point). Generally a port attached to a host or device. NL_Ports communicate with other NL_Ports and with FL_Ports.

NA

Not Applicable

Optical Carrier Level N (OC-N)

The optical signal that results from an optical conversion of an STS-N signal. SDH does not make the distinction between a logical signal (e.g. STS-1 in SONET) and a physical signal (e.g. OC-1 in SONET). The equivalent SDH term for both logical and physical signals is synchronous transport module level M (STM-M), where M=(N/3). There are equivalent STM-M signals only for values of N=3,12,48, and 192.

OC-3

SONET 155.52 Mbps standard

OC-12

SONET 622.08 Mbps standard

OC-48

SONET 2.488 Gbps standard

PLOGI

Port (N_Port) Login Extended Link Service (See FC-FS.)

Point Multi-Point

A topology where one unit can communicate with multiple units.

Point-to-Point

A topology where two points communicate

Port

An access point in a device where a link attaches

Port (N_Port) Login (PLOGI)

An FC-2 defined login procedure used by N_Ports (e.g. hosts and devices) to register (identify) with each other and exchange parameters before communication may occur for ULPs.

Private Loop

An Arbitrated Loop which stands on its own, i.e., it is not connected to a Fabric.

Private NL_Port

An NL_Port which only communicates with other ports on the loop, not with the Fabric. Note that a Private NL_Port may exist on either a Private Loop or a Public Loop.

Public Loop

An Arbitrated Loop which is connected to a Fabric.

Public NL_Port

An NL_Port which may communicate with other ports on the Loop as well as through an FL_Port to other N_Ports connected to the Fabric.

PVC

(Permanent Virtual Circuit) A pre configured logical connection between two ATM systems.

SAM-2

ITS Project 1157D, SCSI Architecture Model—2 (See 2.3.)

Sequence

A group of related frames transmitted unidirectionally from one N_Port to another.

SCSI

Small Computer System Interface, any revision.

SCSI-3

Small Computer System Interface-3, the SCSI architecture specified by SAM-2 and extended by the companion standards referenced in SAM-2.

SCSI-FCP

Fibre Channel protocol for SCSI (refer to FCP, FCP-2 above)

SFC

(Simple Flow Control) A mechanism wherein 2 bytes in the PAUSE field in the BBW_Header carries a non-zero value indicating the number of 512-bit time units to pause transmission (used in FC-BBW protocols)

SR Flow Control

Selective Retransmission sliding window Flow Control Protocol applied between two BBW_ATM devices used for both flow control and error recovery (used in FC-BBW protocols)

Soft Zone

A Zone consisting of Zone Members which are made visible to each other through Client Service requests. Typically, Soft Zones contain Zone Members that are visible to devices via Name Server exposure of Zone Members. The Fabric does not enforce a Soft Zone. Note that well known addresses are implicitly included in every Zone.

SVC

Switched Virtual Circuit. A virtual link established through an ATM network. Used to establish the link end-points dynamically as the call is established. The link is removed at the end of the call.

Switch

enabling devices for large fabrics. Can be connected together to allow scalability to thousands of nodes

Target

A SCSI device that executes a command from an initiator to perform a task. Typically a SCSI peripheral device is the target but a host adapter may, in some cases, be a target.

T_Port

A port on INRANGE/Qlogic switches that can be used to cascade/extend switches. T_Ports are not interoperable with other vendor's ports. Note that all INRANGE ports can act as any type (T/F/FL) of port.

ULP

Upper layer protocol (See FC-FS.). Different communication protocols that can be carried by Fibre Channel.

WAN

Wide Area Network. A network in which computers are connected to each other over a long distance, using telephone lines and satellite cormnunications.

WDM

Wavelength Division Multiplexing. A method for separating several communication channels within one fibre by using different colors of light to separate the channels

Zoning

A logical separation of traffic between host and resources. By breaking up into zones, processing activity is distributed evenly. Zoning is primarily used for security (e.g. to prevent host access to certain devices).

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A probe system adapted for use in a channel director comprising:
at least one probe being capable of being associated with at least one port associated with said channel director;
a mechanism for copying all ingress and egress data to/from a fiber channel port to the said probe for analysis.

2. A probe system as claimed in claim 1, wherein said channel director is a storage area network.

3. A probe system as claimed in claim 2, wherein said storage area network includes a fibre channel architecture.

4. A probe system as claimed in claim 2, wherein said mechanism comprises a mirroring capability to copy the data associated with said port to said probe.

5. A probe system as claimed in claim 1, wherein said probe is a software device.

6. A probe system as claimed in claim 1, wherein said probe is a hardware device.

7. A probe system as claimed in claim 1, wherein said mechanism reflects an optical energy signal on the transmit side of the port, wherein said optical energy is transmitted to said probe.

8. A probe system as claimed in claim 7, wherein approximately 10 percent of said optical energy signal is reflected.

9. A probe system as claimed in claim 1, wherein said mechanism reflects an optical energy signal on the receive side of a port, wherein said optical energy is transmitted to said probe.

10. A probe system as claimed in claim 9, wherein approximately 10 percent of said optical energy signal is reflected.

11. A probe system as claimed in claim 1, wherein said mechanism is an external fibre channel patch panel that replicates data for a given fibre channel port to said port.

12. A probe system as claimed in claim 1, wherein said mechanism accomplishes an internal replication of data within a switch to a probe.

13. A probe system as claimed in claim 1, wherein said mechanism accomplishes an internal replication of data within a director to said probe.

14. A method for monitoring data ingress and egress in a storage area network comprising:
providing at least one probe on at least one port associated with a device in said storage area network;
mirroring a portion of a signal ingress and/or egress associated with said port using said probe to a monitoring location;
obtaining information regarding data ingress and/or data egress obtained using said mirrored signal.

15. A method as claimed in claim 14, further comprising generating statistics on the information provided by said probe.

16. A method as claimed in claim 15, further comprising viewing said statistics.

17. A method for monitoring data ingress and egress in a storage area network comprising:
means for monitoring data on at least one port associated with a device in said storage area network;
means for mirroring a portion of a signal ingress and/or egress associated with said port using said probe to a monitoring location;
means for obtaining information regarding data ingress and/or data egress obtained using said mirrored signal.

18. A method as claimed in claim 17, further comprising means for generating statistics on the information provided by said means for detecting.

19. A method as claimed in claim 18, further comprising means for viewing said statistics.

20. A method as claimed in claim 19, further comprising means for storing said statistics.
